(19) United States
(12) Patent Application Publication
(10) Pub. No.: US 2006/0245834 A1
(43) Pub. Date: Nov. 2, 2006

(54) Multi-orientation table for a drill press

(75) Inventors: Carlton Russell Lay, Greenville, SC (US); Kenneth M. Brazell, Piedmont, SC (US); Bernhard Nortmann, Tin Shi Wai (HK); Jeanne White, Newton, NC (US); Todd M. Chipner, Lantau Island (HK); Huabo Li, YongXin Zone Nanning City (CN)

Correspondence Address: BRINKS HOFER GILSON & LIONE, P.O. BOX 10395, CHICAGO, IL, 60610, US

(73) Assignee: Eastway Fair Company Limited (a BVI company)

(21) Appl. No.: 11/117,010

(22) Filed: Apr. 28, 2005

(51) Int. Cl. B23B 39/00

(52) U.S. Cl. 408/89

(57) ABSTRACT

Accordingly, a work tool is provided that features a table that can be rotated about all three axes of a traditional coordinate system. The work tool features a housing that contains a tool that is translatable along an axis to make contact with a workpiece. A table for mounting the workpiece is also connected to the housing. The table is rotatable about the axis along which the tool is translated to make contact with the workpiece. The table is also rotatable about the two other axes perpendicular to the axis that the tool moves along. Three separate locks are provided, each to maintain the table stationary about one of the three axes. The three axes are each controlled by a handle attached to the locking mechanisms.

### BACKGROUND

This invention relates to a work tool and in particular to a table for a work tool. Many tools feature housings that contain the mechanical and electrical features that allow the tool to operate. For example, a drill press housing typically contains a vertical column that is attached to a base. A head section is attached to the column and typically contains a motor to provide torque to a chuck in which a drill bit or other rotational tool is removeably attached. Additionally, the chuck can translate upwards and downwards with respect to the head section to make contact with the workpiece.

A drill press also normally includes a table upon which a workpiece is placed such that the rotating tool can alter the workpiece located on the table. Drill press tables are normally aligned such that their top surface is parallel to the floor. This orientation will cause the rotating tool to alter the workpiece along a direction perpendicular to the top surface of the table.

Many drill presses provide tables that can rotate to alternate relative orientations. For example U.S. Pat. No. 5,765,273 entitled “Drill Press Having a Pivotable Table” discloses the use of a drill press with a table that rotates about the two horizontal axes that are parallel to the floor. While this table rotates about these two axes, the table cannot rotate about the axis along which the chuck and tool translate in order to make contact with a workpiece on the table. It is also known to provide a table that may rotated about the three major axes of a coordinate system as shown in U.S. Pat. No. 4,502,457 entitled “Universal Multiple Angle Workpiece Holder With Multiple Tool Conversion Features.” This table can rotate about the three axes, but is not connected to a tool housing. Additionally, this patent discloses a table that operates in a complicated manner and requires the use of external tools, such as wrenches or screwdrivers, to operate and lock the table in a particular orientation.

### BRIEF SUMMARY

The present invention solves one or more of the shortcomings above by providing an improved design for a rotatable table for a work tool. Accordingly, a work tool is provided that features a table that can be rotated about two horizontal axes and a vertical axis. The work tool features a housing that contains a tool translatable along the vertical axis to make contact with a workpiece. The housing is connected to a column that extends between the base and housing. A table for mounting the workpiece is connected to the column, and is located between the base and the housing. The table is rotatable about the vertical axis. The table is also rotatable about two horizontal axes. Three locks are provided, each to maintain the table stationary with respect to one of the three axes.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of one embodiment of a drill press;

FIG. 2 is a second perspective view of the drill press of FIG. 1 showing the table rotated about a first horizontal axis;

FIG. 3 is a third perspective view of the drill press of FIG. 1 showing the table rotated about a second horizontal axis;

FIG. 4 is a perspective view of one embodiment of a table assembly;

FIG. 5 is a perspective view of the table assembly of FIG. 4 shown with the table removed;

FIG. 6 is a cross-sectional view of the table assembly of FIG. 4 showing the view from line 6-6 of FIG. 4;

FIG. 7 is a right side view of the table assembly of FIG. 4; and

FIG. 8 is a left side view of the table assembly of FIG. 4;

FIG. 9 is a perspective view of the pivot bracket of the table assembly of FIG. 4;

FIG. 10 is a top view of the pivot support of the table assembly of FIG. 4;

FIG. 11 is an exploded view of the components of the embodiment the first lock of FIG. 4 of the table assembly;

FIG. 12 is an exploded view of the components of a second embodiment of the first lock of the table assembly; and

FIG. 13 is a front view of the table assembly of FIG. 4.

### DETAILED DESCRIPTION OF THE DRAWINGS AND THE PREFERRED EMBODIMENTS

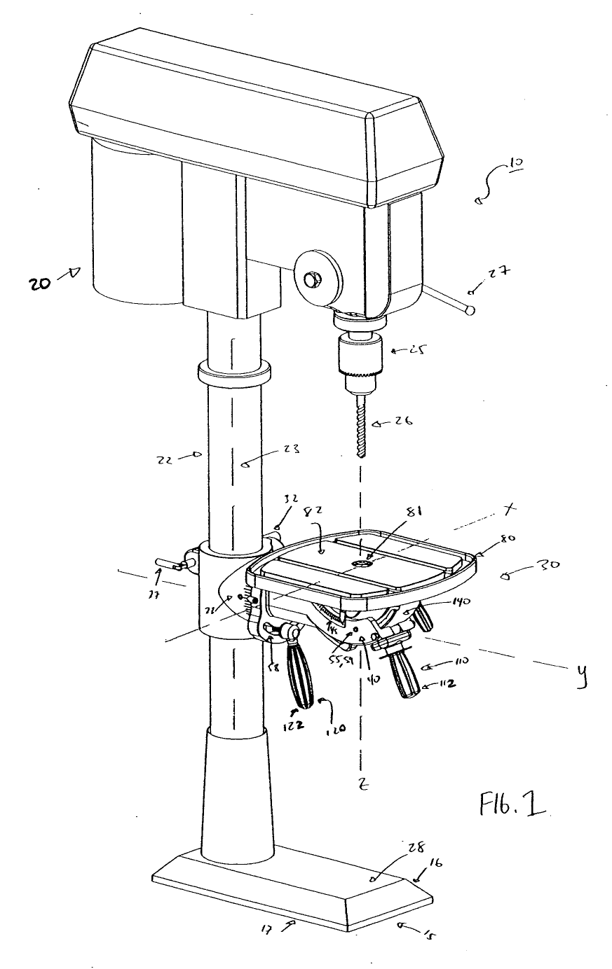

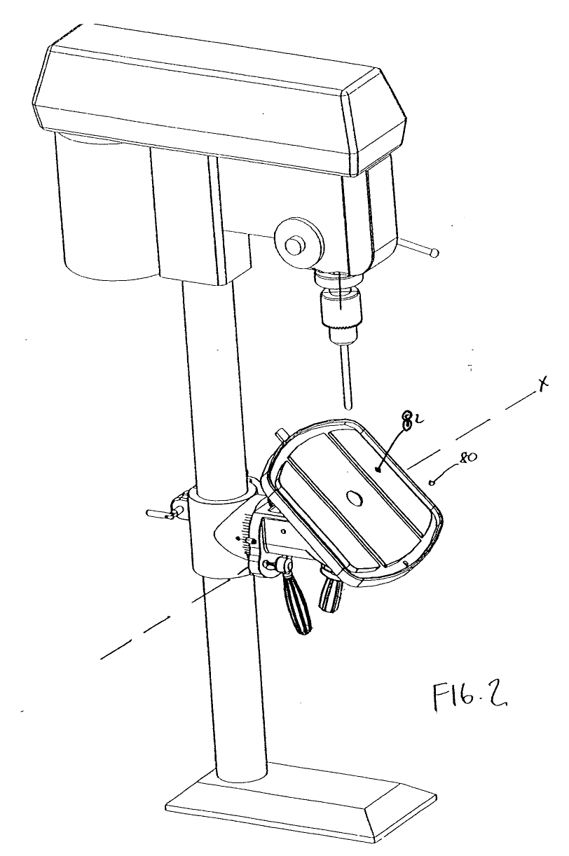

With reference to FIG. 1, a work tool 10 having a rotatable table 80 is provided. The work tool 10 can be a tool that uses a moving or rotating tool 26 to alter a workpiece (not shown). Examples of such work tools include band saws, drill presses, router tables, miter saws, and table saws. The embodiments contained herein specifically describe and illustrate the use of the rotatable table in combination with a drill press, but other tools may also be fitted to incorporate the rotatable table design.

As shown in FIG. 1, the work tool 10 includes a tool housing 20, a column 22, base 28, and a table assembly 30. The column 22 is vertically oriented and is attached to the base 28. The housing 20 is attached to the end of the column 22 opposite the base 28. The housing 20 features a motor (not shown) and a rotatable chuck 25, which supports a tool 26. The chuck 25 and the tool 26 are configured to translate in an upward and downward manner relative to the table assembly 30 by actuating a handle 27. The structure for moving the chuck 25 and tool 26 up and down by actuating the handle 27 is known in the art.

The drill press 10 contains a front side 15, a right side 16, and a left side 17. As is shown in FIG. 1, the front side 15 is defined as the side where the tool 26 and the column 22 are in front of the user when the user faces the work tool 10 from that side. The user normally operates the drill press 10 by standing by the front side 15, although the user may operate the drill press 10 from different positions.

As is shown in FIGS. 1, 4, and 7, the preferred embodiment of the table assembly 30 is connected to the column 22 by a support bracket 32. The support bracket 32 includes a collar 34 that wraps around the column 22. The collar 34 does not surround the entire periphery of the column 22, but contains a small collar gap 34a. The collar gap 34a is provided to allow the collar 34 to be tightly held around the column 22 or be loosened about the column 22 to allow the table assembly to be translated upwards or downwards with respect to the column 22. The table assembly 30 may be raised and lowered about the column 22 with the translation mechanism 38. In other embodiments other structures that are known by one skilled in the art may by used. The translation mechanism 38 includes a pinion gear that rotates on a shaft (not shown) connected to a translation handle 38a. The column 22 may form a rack gear (not shown) configured to mesh with the pinion gear. Because the rack gear on the column 22 remains stationary, rotation of the translation handle 38a causes the table assembly 30 to translate up or down relative to the column 22.

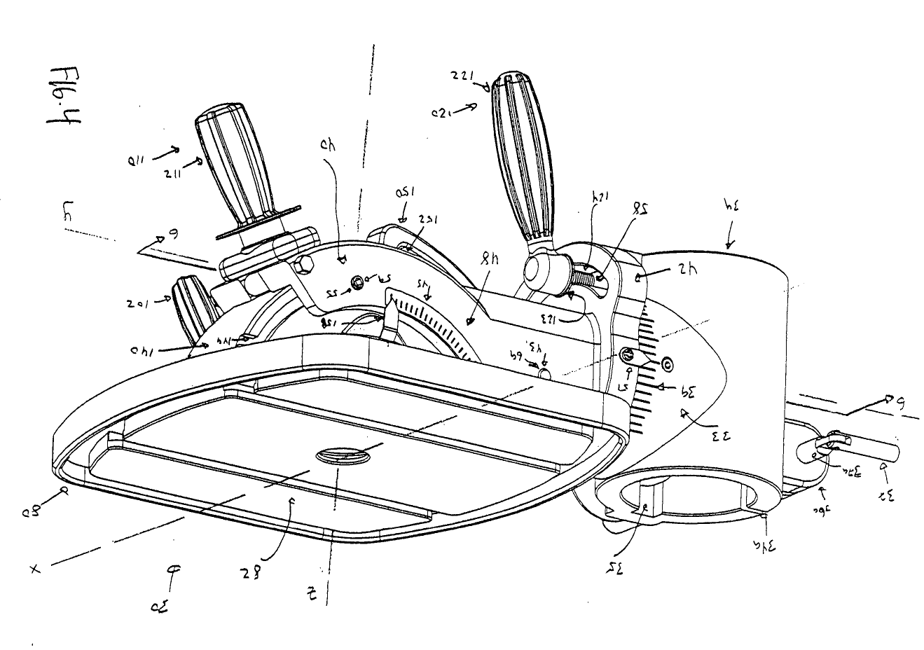

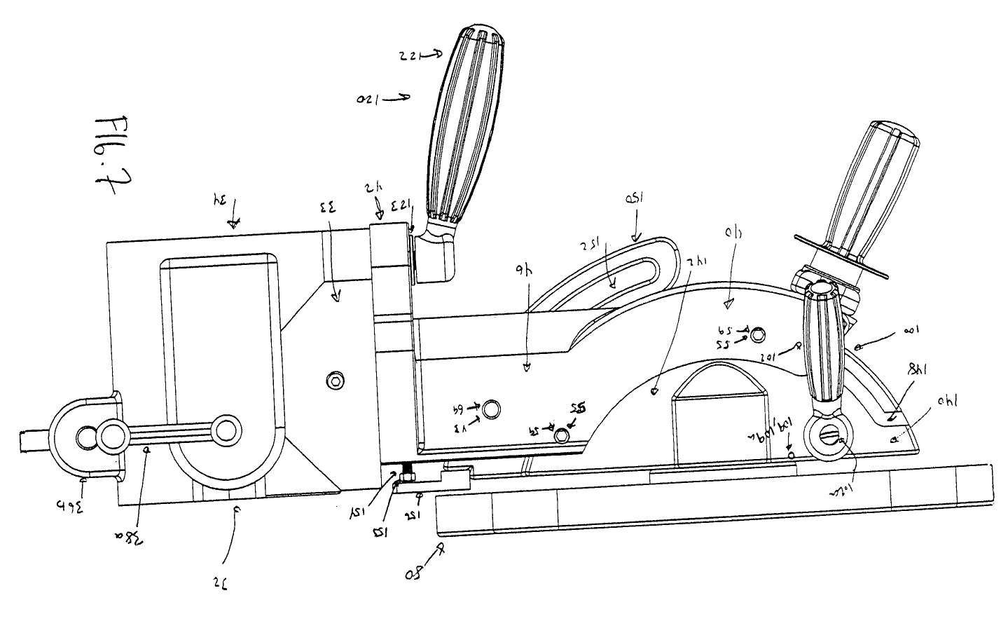

As illustrated in FIG. 4, the collar 34 contains two brackets 36a, 36b (shown in FIG. 7) that extend from the collar 34 on each side of the collar gap 34a. Each bracket 36 contains a tapped hole (not shown), which are coaxial and have the same diameter. When the table assembly 30 is positioned at the desired height relative to the column 22, the table assembly 30 is fixed by rotating a tightening handle 37. This causes the rotation of a threaded tightening shaft 37a that is inserted into each of the tapped holes. Rotating the tightening handle 37 causes a mating surface (not shown) of the tightening handle 37 to make frictional contact with an outer surface of a bracket 36. This frictional contact will maintain the table assembly 30 at the desired height relative to the housing 20. Additionally, the table assembly 30 will not rotate about the vertical axis 23 of the column 22 because the collar 34 contains a keyway 35, or similar structure known in the art, thereby preventing such rotation.

The table assembly 30 includes a table 80 that is rotatable about two horizontal axes and a vertical axis. In the preferred embodiment shown in FIGS. 1 and 4, the table assembly 30 is rotatable about the vertical axis Z, which is oriented along the line that the tool 26 and the chuck 25 move when they are raised and lowered by the translation handle 27. In addition, the table assembly 30 is rotatable about a horizontal axis Y, which is along a line through the centerline 23 of the column 22 through the vertical or vertical axis Z. Finally, the tool assembly 30 is rotatable about a horizontal axis X, which is perpendicular to the vertical axis Z and the horizontal axis Y. In the preferred embodiment, the vertical axis Z, and the two horizontal axes Y, X, are each mutually perpendicular from each other, but in alternate embodiments the axes may be oblique from each other.

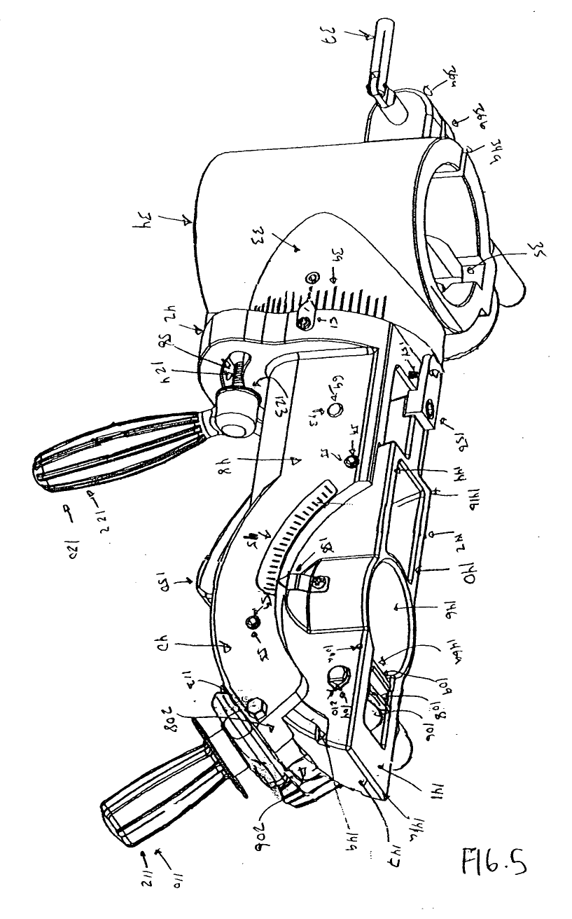

As is shown in FIGS. 1, 5, 7, and 11, the table 80 rotates about the vertical axis Z by actuation of the pivot bracket 140. The pivot bracket 140 has a top surface 141 with a right shoulder 142 and left shoulder 144 that are preferably semi-circular shaped with the diameter forming the length of the top surface 141. The bottom surface 147 (shown in FIG. 5) is curved and extends from the front edge 141a of the top surface 141 around the half circle to the rear edge 141b of the top surface 141 and is adjacent to the outwardly-directed edge of the shoulders 142, 144.

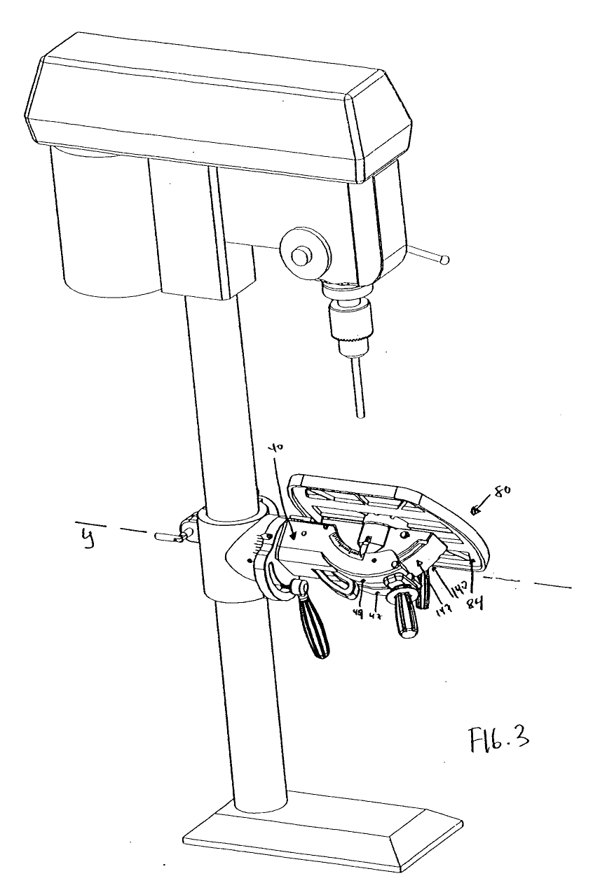

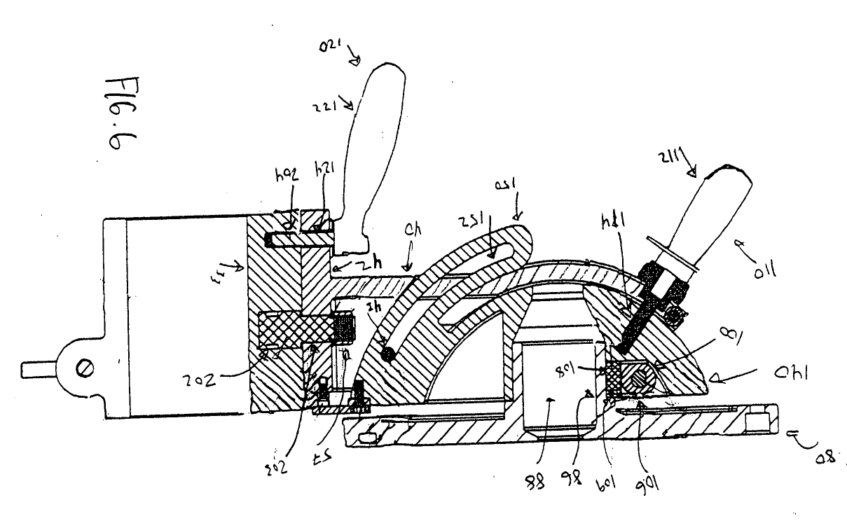

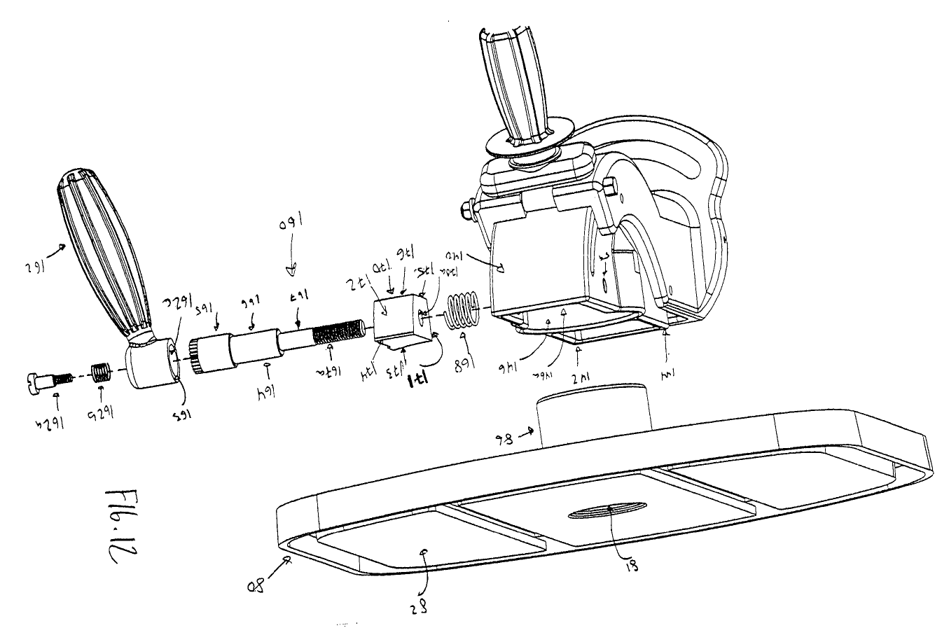

The table 80 features a top surface 82 and a bottom surface 84 (shown in FIG. 3). The table 80 and structures forming the table assembly 30 are preferably made with steel but it should be understood by one skilled in the art that any other material having sufficient strength for the application may be used. The top surface 82 is preferably a flat, relatively smooth surface for supporting a workpiece. As shown in FIGS. 6 and 11, a hollow cylindrical projection 86 extends from the bottom surface 84 of the table 80. The projection 86 contains a hole (not shown) through the length of the cylindrical projection 86 and is the same diameter as an aperture 81 located near the center of the top surface 82 of the table. The aperture 81 and the hole are provided in the table to allow for passage of the drill bit to allow for thru cuts in the workpiece. The cylindrical projection 86 is received in a cylindrical aperture 146 extending through the top surface 141 of the pivot bracket 140. The cylindrical aperture 146 has a diameter slightly larger than the cylindrical projection 86 and has a sufficient depth such that the bottom surface 84 of the table 80 will rest on a top surface 141 of the pivot bracket 140, as illustrated in FIGS. 5-7. Unless the first lock 100 (shown in FIGS. 5-7) is used to maintain the table 80 in a specific orientation about the vertical axis Z, the table 80 is free to rotate about the vertical axis Z with the cylindrical projection 86 inserted into the cylindrical aperture 146. As shown in FIG. 5, the cylindrical aperture 146 has an opening 146a between the right and left shoulders 142, 144 at the section of the aperture 146 closest to the front edge 141a.

The table 80 is adjustable with respect to the first horizontal axis X, the second horizontal axis Y, and the vertical axis Z. A first lock 100 is used to maintain the user selected table 80 position with respect to the vertical axis Z, a second lock 110 is used to maintain the user selected table 80 position about the first horizontal axis X, and a third lock 120 is used to maintain the user selected table 80 position with respect to the second horizontal axis Y.

With the first lock 100 not engaged the user can rotate the table 80 about the vertical axis Z by holding and spinning the table 80. It is preferable that the second and third locks 110, 120 be engaged when rotating the table 80 about the vertical axis Z to allow for precise rotation. The projection 86 from the bottom surface of the table 84 is free to rotate within the cylindrical aperture 146 in the pivot bracket 140. When the table 80 is in the desired orientation about the vertical axis Z, the user can then apply the first lock 100 to maintain the table 80 fixed with respect to the vertical axis Z and withstand the vibrational forces produced by the operation of the drill press 10 and any external forces that may be applied to the table 80 during operation.

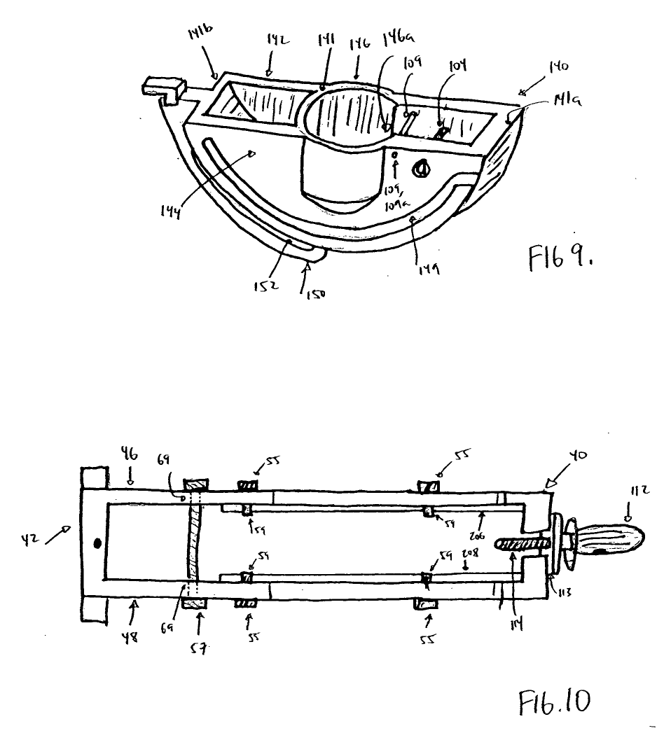

As seen in FIGS. 5, 6, 7, and 11, the table is locked into a user-selected orientation about the vertical axis Z using the first lock 100. The first lock 100 preferably includes a first handle 102, a first mating surface 103 located on the first handle 102, and a first shaft 104. As shown in exploded FIG. 11, the first shaft 104 is “D-shaped” along the majority of its length. The first shaft 104 is inserted into a corresponding “D-shaped” aperture 106a into a cam 106. As illustrated in FIG. 9, the right and left shoulders 142, 144 of the pivot bracket 140 each have apertures 151 through which the first shaft 104 extends and is rotatably retained by a C-ring 210 or another method known in the art. The first lock 100 further includes a press piece 108 disposed between the cam 106 and the opening 146a in the cylindrical aperture 146 such that the press piece 108 is adjacent to the cylindrical projection 86 when inserted into the cylindrical aperture 146. The first handle 102 and the first shaft 104 are connected with a flat head screw 102a and a spring 102b, or in any other method as is known in the art.

In operation, when the table 80 is in the desired orientation about the vertical axis Z, the table is maintained in the selected position using the first lock 100. The preferred first lock 100 operates in a similar manner to a quick release lock on a bicycle wheel. To maintain the table 80 about the vertical axis Z, the first handle 102 is rotated, thereby rotating the cam 106. When the cam 106 is rotated the profile of the cam 106 causes the cam 106 to contact the press piece 108 such that the press piece 108 moves towards the cylindrical projection 86. After sufficient rotation of the cam, the press piece 108 and the cylindrical projection 86 are frictionally connected, thereby preventing further rotation of the table 80 about the vertical axis Z. The press piece 108 is retained in position by a rod 109 that is inserted through holes 109a in the right and left shoulders 142, 144 of the pivot bracket 140. Additionally, the mating surface 103 of the first handle 102 is in frictional contact with the surface of the shoulder 142 to lock the table 80 in place about the vertical axis Z. It should be understood by one skilled in the art that although the handle is shown as extending from the right shoulder 142, the handle 102 can also extend from the left shoulder 144, or any other orientation such that the handle 102 operates the locking mechanism to establish the frictional connection to lock the table 80. The table 80 can be unlocked, using the first lock 100 which will allow table 80 rotation about the vertical axis Z. To unlock the table the user turns the first handle 102 in the opposite direction, thereby removing the frictional connection between the press piece 108 and the cylindrical projection 86, which will allow the table 80 to freely rotate about the vertical axis Z.

An advantage of the preferred embodiment is that the connection between the table 80 and the pivot bracket 140, and the components forming the first lock 100, allow the table to be positioned and secured about the vertical axis Z without the use of external tools.

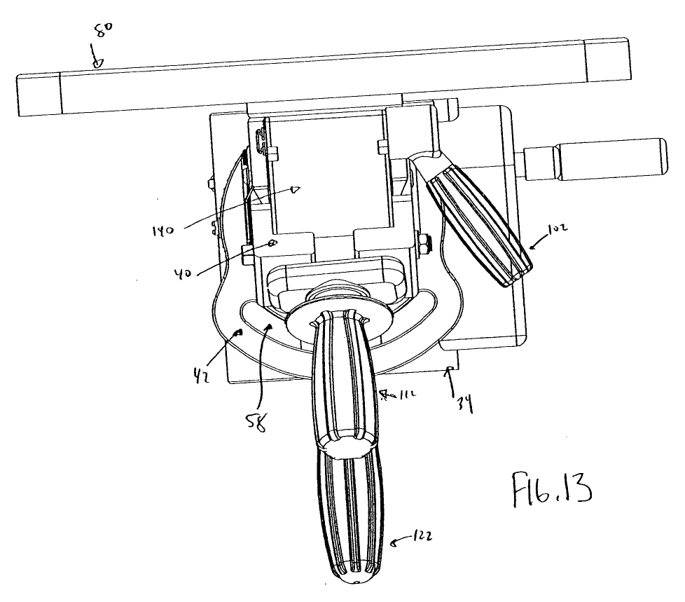

The table 80 can also be locked in the user-selected orientation about the vertical axis Z using a second preferred embodiment, the first lock 160 shown in FIG. 12. The first lock 160 includes a first handle 162, a first mating surface 163, and a first shaft 164. The first handle 162 and the first shaft 144 are connected with a flat head screw 162a and a spring 162b, or in any other method as is known in the art. The first shaft contains three sections. A first section 165 is sized to be received within a hollow section 162c of the first handle 162, the second section 166 is sized to be inserted through an aperture (not shown) in the right shoulder 142 that has a slightly larger diameter than the diameter of the second section 166. The first shaft 164 also includes a third section 167 that has a threaded section 167a. The threaded section 167a of the first shaft 164 will engage a threaded aperture 59 in the left shoulder 144 of the pivot bracket 140.

The third section 167 of the first shaft 164 is also inserted into an aperture 168a in a block 170 between the right and left shoulders 142, 144. The block 170 has a cam surface 171 that faces the cylindrical aperture 146 when engaged with the first shaft 164. The cam surface 171 is oblique, or not parallel, with respect to the surface 172 on the block opposite from the cam surface 171. In other words, the top edge 173 of the cam surface 171 is further from the top edge 174 of the opposite surface 172 than the bottom edge 175 of the cam surface 171 is from the bottom edge 176 of the opposite surface 172. Additionally, the cam surface 171 is slightly concave with a concavity of the same radius as the cylindrical projection 86 to allow the cam surface 171 to engage the cylindrical projection 86. A spring 168 surrounds the third section 167 of the first shaft 164 between the left shoulder 144 and the block 170 to bias or maintain the block 170 between the shoulders 142, 144 to engage the cylindrical projection 86.

An advantage of this second preferred embodiment is that the connection between the table 80 and the pivot bracket 140, and the components forming the first lock 160, allow the table to be positioned and secured about the vertical axis Z without the use of external tools.

In operation, when the table 80 is in the desired orientation about the vertical axis Z, the table 80 is maintained in the selected position using the second preferred embodiment of the first lock 160. The second preferred embodiment first lock 160 operates in a similar manner to a quick release lock on a bicycle wheel. To maintain the table 80 about the vertical axis Z, the first handle 162 is rotated, the first shaft 164 correspondingly rotates, thereby rotating the block 170. When the block 170 is rotated the top edge 173 of the cam surface 171 moves towards the cylindrical projection 86 and with sufficient rotation of the first handle 162, the top surface 173 will contact and establish a frictional connection with the cylindrical projection 86. This frictional contact will lock the table 80 in the position about the vertical axis Z selected by the user. Additionally, the mating surface 163 of the first handle 162 will make frictional contact with the surface of the shoulder 142 to lock the table 80 in place about the vertical axis Z. It should be understood by one skilled in the art that although the handle is shown as extending from the right shoulder 142, the handle 162 can also extend from the left shoulder 144, or any other orientation such that the handle 162 operates the locking mechanism to establish the frictional connection to lock the table 80. The table 80 can be unlocked, using the first lock 160 which will allow table 80 rotation about the vertical axis Z. To unlock the table the user turns the first handle 162 in the opposite direction, thereby removing the frictional connection between the top edge 173 of the cam surface 171 and the cylindrical projection 86, which will allow the table 80 to freely rotate about the vertical axis Z.

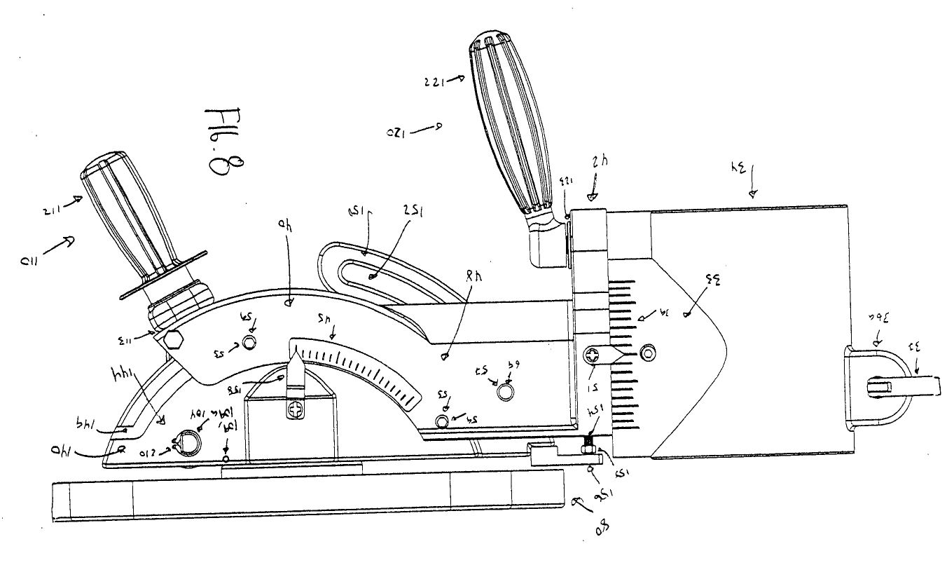

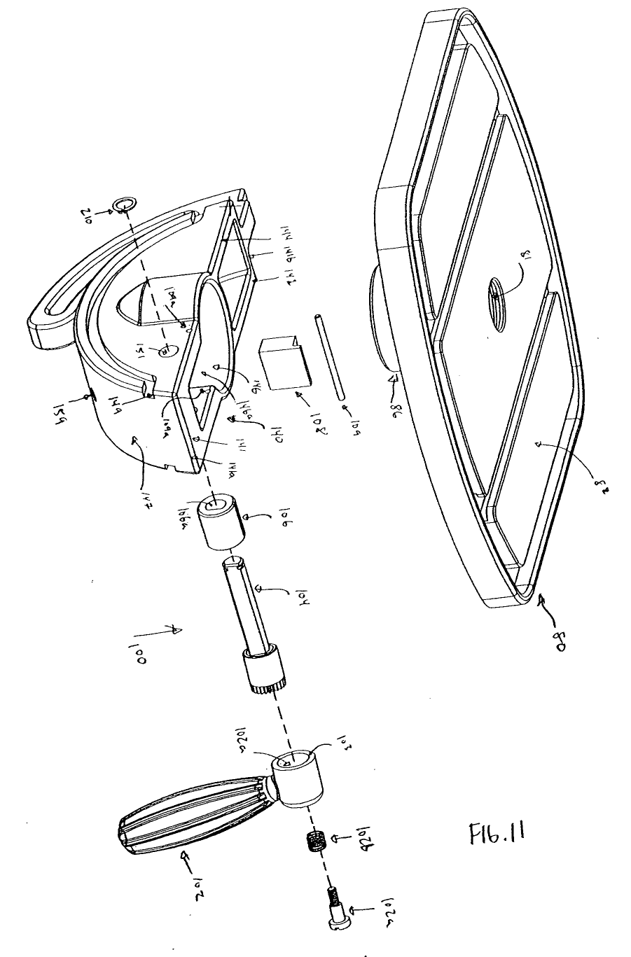

As is seen in FIGS. 5-7 and 9-10, the table 80 may be rotated about the first horizontal axis X using a connection between the pivot bracket 140 and the pivot support 40. The table 80 can also be maintained in an orientation selected by the user relative to the first horizontal axis X by actuation of the second lock 110. The right and left shoulders 142, 144 each include an inscribed slot 148, 149 (slot 149 is best shown in FIG. 9, slot 148 is representative of slot 149) on the outward facing surfaces of each shoulder 142, 144. Each inscribed slot 148, 149 is curved about the first horizontal axis X of rotation. As best seen in FIGS. 7 and 8, the pivot support 40 contains a center member 42 and right and left members 46, 48 extending substantially perpendicular to the center member 42 in a direction away from the column 22 (FIG. 1). The right and left members 46, 48 are positioned such that the pivot bracket 140 fits within the space between the right and left members 46, 48. Two apertures 59 are formed on each of the right and left members 46, 48. The apertures are positioned such they both open to the inscribed slots 148, 149 formed on the pivot bracket shoulders 142, 144. As best shown in FIG. 10, the fasteners 55 are inserted into the apertures to protrude into the volume formed by the inscribed slots 148, 149. These fasteners are retained in the apertures by C-rings or other structures known in the art. With the fasteners 55 inserted into the inscribed slots 148, 149, the pivot bracket 140 is free to rotate about the first horizontal axis X, but otherwise prohibited from moving about the pivot support 40. Additionally, the right and left members 46, 48 have curved ledges 206, 208 (shown in FIGS. 5 and 10) that support the pivot bracket 140 when the pivot bracket 140 rotates about the first horizontal axis X.

In the preferred embodiment, shown in FIGS. 6-8, the pivot bracket 140 features a curved protrusion 150 that extends from a portion of the bottom surface 147 of the pivot bracket 140. The curved protrusion 150 includes a curved slot 152. Both the curved protrusion 150 and the curved slot 152 are curved about the first horizontal axis X. The right and left members 46, 48 each include a coaxial aperture 69 through which a member 43 is extended. The member 43 can be a bolt, pin, peg, or similar shaped structure. The member 43 extends through the curved slot 152 in the curved protrusion 150. The member 43 is retained in the aperture 69 of the right and left members 46, 48 by a C-ring or similar structure known in the art. The member 43 inserted through the curved slot 152 provides additional stability for the pivot bracket 140 as it rotates about the first horizontal axis X. Additionally, the curved slot 152 defines the rotational limits of pivot bracket 140 and the table 80 about the first horizontal axis X. The pivot support 40 further includes a scale 45. As shown in FIG. 5, the pivot bracket 140 includes a needle 158 extending from the pivot bracket 140 in order to translate along the scale 45 so as to represent the orientation of the table 80 with respect to the first horizontal axis X.

In operation, the table 80 may be rotated about the first horizontal axis X when the second lock 110 is not engaged. The user preferably pulls the second handle 112 and rotates the table 80 about first horizontal axis X. The rotational force provided by the user will cause the movement to remain about the first horizontal axis X because the movement in other directions will be constrained to by the member 43 in the curved slot 152 and the fasteners 55 in the inscribed slots 148, 149. Additionally, it is preferred that the user only rotate the table about the first horizontal axis X when the first and third locks 100, 120 are engaged to allow for precise movements of the table about the first horizontal axis X only. The user will observe the scale 45 on the pivot support 40 and the needle 158 on the pivot bracket 140 when rotating the table about the first horizontal axis X to establish the desired table 80 orientation. When the table 80 is placed in the desired orientation about the first horizontal axis X, the second lock 110 may be engaged to stabilize the table against the vibrations and external forces felt by the table 80 during operation.

In the preferred embodiment illustrated in FIGS. 5-8, the pivot bracket 140, and the table 80, can be aligned to be substantially parallel to the floor. A tab 156 is preferably attached to the rear of the top surface 141 of the pivot bracket 140. Correspondingly, a positioning member 154 forms an adjustable protrusion from the center member 42 of the pivot support 40. The positioning member 154 can be a flat head screw inserted into a tapped hole in the center member 42 of the pivot support 140, or other structures that would be known to one of ordinary skill in the art to provide a surface for the tab 156 to rest on and have an adjustable height. The tab 156 is sized such that it rests on the top of the positioning member 154 when the pivot bracket 140 is substantially parallel to the floor. The height of the positioning member 154 is adjustable such that when the tab 156 contacts the top of the positioning member 154 the table 80 will be horizontal, or parallel to the floor when the table is not rotated about the second horizontal axis Y. The lock nut 155 is used to maintain the positioning member 154 at the correct height. It will be understood that other structures can be substituted for the lock nut 155 that will serve to maintain the positioning member 154 at a desired height.

As seen in FIGS. 5-8, in operation the pivot bracket 140 can be locked in a specific orientation about the first horizontal axis X with the second lock 110. The preferred second lock 110 works in a similar manner to a quick release lock on a bicycle wheel. The second lock 110 preferably includes a second handle 112, a second mating surface 113, and a second shaft 114. The second handle 112 and second shaft 114 can be connected with a flat head screw and spring (not shown) similar to that used to connect the first handle 102 and the first shaft 104, or by any other method known to those of ordinary skill in the art. As shown in FIG. 6, the second shaft 114 is rotatably inserted into a tapped hole 159, shown in FIG. 11, on the bottom surface 147 of the pivot bracket 140. The right and left members 46, 48 each include bottom surfaces 47, 49 (shown in FIG. 3) that are curved about the first horizontal axis X. The bottom surfaces 47, 49 contact the second handle mating surface 113 when the second lock 110 is engaged.

In operation, when the table 80 is in the desired orientation about the first horizontal axis X, the user may transfer the second lock 110 to the locked position by tightening the second handle 112, which inserts the second shaft 114 further into the tapped hole. Eventually the second handle mating surface 113 makes frictional contact with the bottom surfaces 47, 49 of the right and left members 46, 48 to secure the pivot bracket 140 in the selected orientation about the first horizontal axis X. The second lock 110 can be returned to the unlocked position, thereby allowing further rotation of the table about the first horizontal axis X, by rotating the second handle 112 in the opposite direction, which will remove the frictional connection between the mating surface 113 of the second handle and the bottom surfaces 47, 49 of the right and left members 46, 48 of the pivot bracket 140.

An advantage of the preferred embodiment is that the connection between the pivot bracket 140, the pivot support 40, and the components forming the second lock 110 allow the table to be positioned and secured about the first horizontal axis X without the use of external tools.

As shown in FIGS. 5-6, the table assembly 30 is rotatable about the second horizontal axis Y. As illustrated in FIG. 5, the support bracket 32 includes a generally cylindrical projection 33 that extends away from the collar 34 in a direction normal to the centerline 23 of the column 22 (shown in FIG. 1). This projection 33 contains a flat vertical surface (not shown) that is parallel to the centerline of the column 23. As illustrated in FIG. 6, the projection 33 also contains a tapped hole 202 that serves as the axis of rotation about the second horizontal axis Y. The center member 42 of the pivot support 40 contains a corresponding first tapped hole 203 of the same diameter and thread dimensions as the tapped hole 202 on the projection 33. A threaded bolt 57 is inserted through the first tapped hole 203 in the center member 42 of the pivot support 40 and into the tapped hole 202 in the projection 33. This bolt 57 rotatably secures the pivot support 40 to the support bracket 32, and operatively connects the pivot support 40 to the column 22. As shown in FIG. 5, the cylindrical projection 33 includes a scale 39 that has markings corresponding to the angles through which the table assembly 30 can be rotated about the second horizontal axis Y. The center member 42 of the pivot support 140 includes a needle 51 that translates along the scale 39 corresponding to the table position about the second horizontal axis Y.

In operation the table 80 may be rotated about the second horizontal axis Y when the third lock 120 is not engaged. The preferred third lock 120 works in a similar manner to a quick release lock on a bicycle wheel. It is preferred that the user adjusts the table 80 with respect to the second horizontal axis Y when the first and second locks 100, 110 are engaged to allow for precise movements about the second horizontal axis Y. The user pulls either the table 80 or a third handle 122 and rotates the table 80 to the desired orientation. The user may view the scale 39 on the projection 33 and the needle on the center member 42 of the pivot support 40 to set the table 80 in the desired position with respect to the second horizontal axis Y. When the table 80 is in the desired orientation, the third lock 120 is engaged to stabilize the table against the vibrational and external forces applied during operation.

As shown in FIGS. 5-6 and 13, the third lock 120 preferably includes a third handle 122 with a third mating surface 123, and a third shaft 124. The third handle 122 and third shaft 124 can be connected with a flat head screw and spring (not shown) similar to that used to connect the first handle 102 and the first shaft 104, or by any other method known to those of ordinary skill in the art. The third shaft 124 extends through a pivot support slot 58 located on the center member 42. The pivot support slot 58 is curved about the second horizontal axis Y and defines the range of movement of table 80 relative to the second horizontal axis Y. As shown in FIG. 6, the third shaft 124 is threadingly inserted into a second tapped hole 204 in the projection 33 of the support bracket 32. The second tapped hole is located at approximately the same distance from the first tapped hole as the radius of the pivot support slot 58 about the second horizontal axis Y.

In operation, the pivot support 40 is maintained in an orientation about the second horizontal axis Y by locking the third lock 120. The user accomplishes this by tightening the third handle 122 which further inserts the third shaft 124 into the second tapped hole 204. When the third mating surface 123 frictionally contacts the center member 42 of the table support 40 the table assembly 30 is maintained in the desired orientation about the second horizontal axis Y. The table assembly 30 may be repositioned about the second horizontal axis Y by unlocking the third lock 120, which is accomplished by turning the third handle 122 in the opposite direction, which will remove the frictional connection between the third mating surface 123 and the center member 42 of the table support.

An advantage of the preferred embodiment is that the connection between the pivot support 40 and the support bracket 32, and the components forming the third lock 120 allow the table to be positioned and secured about the second horizontal axis Y without the use of external tools.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A work tool for contacting a workpiece comprising:
a column;
a housing connected to said column;
a tool connected to said housing translatable along a first axis;
a table rotatably connected to said column, said table being rotatable about said first axis, a second axis, and a third axis;
wherein said table can be maintained in position using a first lock, a second lock, and a third lock;
wherein said first, said second, and said third locks each contain a handle; and
wherein said first, said second, and said third locks can be locked and unlocked using only the handles.

2. The work tool of claim 1 wherein said work tool is a drill press.

3. The work tool of claim 1 wherein said first, second and third axes are mutually perpendicular.

4. The work tool of claim 3 wherein said table is rotatably connected to said housing using a table assembly, said table assembly comprising a pivot support upon which a pivot bracket is rotatable about said second axis, wherein said table is rotatable about said pivot bracket about said first axis.

5. The work tool of claim 3 wherein said first lock comprises a cam and a press piece.

6. The work tool of claim 5 wherein said first lock further comprises a first shaft attached to said first handle and said cam attached to said first shaft.

7. The work tool of claim 6 wherein said first shaft is rotatably mounted through a first aperture on a first surface of said pivot bracket and through a second aperture on an opposite surface of said pivot bracket; said first shaft is oriented in an orientation perpendicular to said first axis.

8. The work tool of claim 7 wherein said first surface of said pivot bracket and said second surface of said pivot bracket each contain slots;
wherein said pivot support features a plurality of projections that ride in said first and second slots; and
wherein each of said first and second slots are curved about said second axis of rotation.

9. The work tool of claim 4 wherein said pivot bracket contains a curved protrustion and a curved slot; a member connected to said pivot housing rides within said curved slot to establish the amount of potential rotation of the pivot bracket about the pivot housing.

10. The work tool of claim 4 wherein a tab is connected to said pivot bracket and a positioning member is movably connected to said pivot housing, said tab being positioned to contact a top surface of said positioning member, wherein said positioning member being adjustable to adjust the orientation of said pivot bracket.

11. A drill press comprising:
a column;
a housing connected to said column;
a tool connected to said housing being translatable along a first axis;
a table rotatably connected to said column, said table rotatable about said first axis, a second axis, and a third axis;
wherein said table can be maintained in position using a first lock, a second lock, and a third lock; and
wherein said first, said second, and said third locks each contain a handle.

12. The drill press of claim 11 wherein said first, second, and third axes are mutually perpendicular.

13. The drill press of claim 12 wherein said first lock comprises a rotatable cam operatively connected to said first handle and a translatable press piece.

14. The drill press of claim 12 wherein said table is rotatably connected to said housing using a table assembly, said table assembly comprising a pivot support upon which a pivot bracket is rotatable about a second axis, wherein said table is rotatable about said pivot bracket about said first axis.

15. The drill press of claim 14 wherein said first lock further comprises a first shaft attached to said first handle and said cam attached to said first shaft.

16. The drill press of claim 15 wherein said first shaft is rotatably mounted in a first aperture through a first surface of said pivot bracket and a second aperture through an opposite surface of said pivot bracket; said first shaft is mounted in an orientation perpendicular to said first axis.

17. The drill press of claim 16 wherein said first surface of said pivot bracket and said second surface of said pivot bracket each contain slots;
wherein said pivot support features a plurality of projections that ride in said first and second slots; and
wherein each of said first and second slots are curved about said second axis of rotation.

18. A drill press of claim 14 wherein said pivot bracket contains a curved protrustion and a curved slot; a member connected to said pivot housing rides within said curved slot to establish the amount of potential rotation of the pivot bracket about the pivot housing.

19. A work tool of claim 14 wherein a tab is connected to said pivot bracket and a positioning member is movably connected to said pivot housing, said tab being positioned to contact a top surface of said positioning member, wherein said positioning member being adjustable to adjust the orientation of said pivot bracket.

20. A table assembly for a work tool comprising:
a table for maintaining a workpiece;
a pivot bracket upon which the table is rotatable about a first axis;
a first lock operatively connected to said table and said pivot bracket;
a pivot housing upon which the pivot bracket is rotatable about a second axis;
a second lock operatively connected to said pivot bracket and said pivot housing;
a support bracket upon which the pivot housing can rotate about a third axis;
a third lock operatively connected to said pivot housing and said support bracket; and
wherein said first, said second, and said third locks each contain a handle.

21. The table assembly of claim 20 wherein said first, second, and third axes are each mutually perpendicular.

22. The table assembly of claim 21 wherein said first lock comprises a rotatable cam operatively connected to said first handle and a translatable press piece.

23. The table assembly of claim 22 wherein said first lock further comprises a first shaft attached to said first handle and said cam attached to said first shaft.

24. The table assembly of claim 23 wherein said first shaft is rotatably mounted through said first and second surfaces of said pivot bracket in an orientation perpendicular to said first axis.

25. The table assembly of claim 23 wherein said first surface of said pivot bracket and said second surface of said pivot bracket each contain slots;
wherein said pivot support features a plurality of projections that ride in said first and second slots; and
wherein each of said first and second slots are curved about said second axis of rotation.

26. The table assembly of claim 21 wherein said pivot bracket contains a curved protrustion and a curved slot; a member connected to said pivot housing rides within said curved slot to establish the amount of potential rotation of the pivot bracket about the pivot housing.

27. A table assembly of claim 21 wherein a tab is connected to said pivot bracket and a positioning member is movably connected to said pivot housing, said tab being positioned to contact a top surface of said positioning member, wherein said positioning member being adjustable to adjust the orientation of said pivot bracket.

28. A drill press comprising:
a column;
a housing connected to said column;
a tool translatably connected to said housing, said tool being translatable along a first axis;
a table assembly rotatably connected to said column;
wherein said table assembly comprises a table rotatably supported about said first axis by a pivot bracket;
a first lock operatively connected to said table and said pivot bracket;
said pivot bracket rotatably supported about a second axis by a pivot support;
a second lock operatively connected to said pivot bracket and said pivot support;
said pivot support rotatably supported about a third axis by a table support member;
a third lock operatively connected to said pivot support and said table support member;
said table support member supported by said housing; and
wherein said first, said second, and said third locks each contain a handle.

29. The drill press of claim 28 wherein said first, second, and third axes are mutually perpendicular with each other.

30. The drill press of claim 29 wherein said first lock further comprises a rotatable cam and a translatable press piece.

31. The drill press of claim 29 wherein said pivot bracket features a first side surface and a second side surface, wherein a first slot is formed on said first side surface and a second slot is formed on said second side surface, wherein said pivot support contains a plurality of projections that ride in said first slot and a plurality of projections that ride in said second slot.

32. The drill press of claim 31 wherein said first slot and said second slot are each curved about said second axis.

33. The drill press of claim 31 wherein said first lock further comprises a first shaft connected to said first handle and said cam, wherein said first shaft is rotatably inserted through an aperture on said first side surface and an aperture on said second side surface of said pivot bracket; wherein said first shaft is rotatably mounted to said pivot bracket in an orientation perpendicular to said first axis.

34. A work tool of claim 29 wherein said pivot bracket contains a curved protrusion and a curved slot; a member connected to said pivot housing rides within said curved slot to establish the amount of potential rotation of the pivot bracket about the pivot housing.

35. A work tool of claim 29 wherein a tab is connected to said pivot bracket and a positioning member is movably connected to said pivot housing, said tab being positioned to contact a top surface of said positioning member, wherein said positioning member being adjustable to adjust the orientation of said pivot bracket.
